(19) United States
(12) Patent Application Publication
(10) Pub. No.: US 2017/0118603 A1
(43) Pub. Date: Apr. 27, 2017

(54) METHOD AND ELECTRONIC DEVICE OF COMMUNICATION FOR TEAM TRAVEL

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventors: Hua KANG, Tianjin (CN); Miao XIE, Tianjin (CN); Lulu ZHOU, Tianjin (CN)

(21) Appl. No.: 15/247,899

(22) Filed: Aug. 25, 2016

Related U.S. Application Data
(63) Continuation-in-part of application No. PCT/CN2016/085298, filed on Jun. 8, 2016.

(30) Foreign Application Priority Data
Oct. 23, 2015 (CN) 2015106982728

(51) Int. Cl. H04W 4/08; H04W 8/26; H04W 4/02

(52) U.S. Cl. CPC H04W 4/08; H04W 4/027; H04W 8/26

(57) ABSTRACT

The present disclosure discloses a method and electronic device of communication for team travel, wherein the method includes: receiving state information periodically reported by a communication terminal of a user in a travel team, the state information comprising a position and a speed of a user; and sending the user position reported by the user to communication terminals of other users, and displaying the user position on map interfaces of the communication terminals of the other users. The method and electronic device of communication for team travel, disclosed by the present disclosure, improve the efficiencies of position sharing and information interaction of team travel, and save the time for the users to manually and actively inquiry the positions of others and obtain information.

### CROSS REFERENCE TO RELATED APPLICATIONS

This application is a continuation-in-part of International Application No. PCT/CN2016/085298, filed on Jun. 8, 2016, which is based upon and claims priority to Chinese Patent Application No. 201510698272.8, filed on Oct. 23, 2015, the entire contents of which are incorporated herein by reference.

### TECHNICAL FIELD

The present disclosure relates to the field of cloud platform communication technology, and particularly to a method and electronic device of communication for team travel.

### BACKGROUND

Started in the United States in the middle of the 20^{th} century, drive travel was popular in western developed countries. In the 21^{th} century, the rapid development of the automobile industry promotes the development of the tourism industry, and lays a foundation for the promotion and popularization of the drive travel, thus making the drive travel stand out from self-help travel. People develop the initial “Sunday drive” into the subsequent “Drive Travel”.

The formation and development of the drive travel industry are established on the basis of rapid economic development, continuous improvement of traffic conditions and increasingly high living standard of people, and the drive travel embodies the idea of “freedom, individuality, exploration, and control”, and now quietly becomes a travel leisure lifestyle loved by young and middle-aged people having a certain consumption ability and consumption concept in large and medium-sized cities. From the view of time, organized and relatively regular drive travel activities might be started in 2000 and started to spread from network to the mass media, i.e., the intervention of televisions, radio broadcast, newspapers and other traditional media from 2003, so that the rapid development of the drive travel is effectively promoted.

At present, during a drive travel, the communication between motorcades can only rely on signals of lighting and whistle, or mobile phone calls, short messages, and IM communication tools, or interphones. The lighting and whistle can only transmit little information, and are not conducive to understanding the content of the information. The mobile phone calls, short messages, and IM communication tools are not suitable for operation during driving, and can cause a great impact on the safety of driving. The interphones can realize intelligent transmission of voice information, but the current positions of users need phonetic description which is not accurate enough, and meanwhile, the interphones have some restrictions, for example, limited frequency, power, and communication distance, can only have one user in the same band for communication, and need single purchase of equipment, thereby causing great disturbance to practical use.

Therefore, the prior art is short of a solution for safe and effective position sharing and information communication during team travel.

### SUMMARY

In order to solve the technical problem in the prior art that position sharing and information communication cannot be performed safely and effectively during team travel, the present disclosure provides a method and electronic device of communication for team travel.

The communication method for team travel of the present disclosure includes: step A: receiving state information periodically reported by a communication terminal of a user in a travel team, the state information comprising a position and a speed of the user; and In Step B: sending the user position reported by the user to communication terminals of other users, and displaying the user position on map interfaces of the communication terminals of the other users.

Based on the same inventive concept, the disclosure also provides an electronic device for team travel, including: a memory, which is used for storing programs; a processor, which is used for reading the programs, and executing: receiving state information periodically reported by a communication terminal of a user in a travel team, the state information comprising a position and a speed of the user; and sending the user position reported by the user to communication terminals of other users, and displaying the user position on map interfaces of the communication terminals of the other users.

Based on the same inventive concept, the disclosure also provides a non-transitory computer-readable storage medium storing executable instructions that, when executed by an electronic device, cause the electronic device to: receiving state information periodically reported by a communication terminal of a user in a travel team, the state information comprising a position and a speed of the user; and sending the user position reported by the user to communication terminals of other users, and displaying the user position on map interfaces of the communication terminals of the other users.

The method and electronic device of communication for team travel, disclosed by the present disclosure, allow the users, during team travel, for example, drive travel, to be able to achieve real-time tracing of the positions of the users in a team through the technical solution of the present disclosure, and achieve mutual communication by voice, thereby realizing a communication function of team travel while ensuring the driving safety. The method and electronic device of communication for team travel, disclosed by the present disclosure, improve the efficiencies of position sharing and information interaction of team travel, and save the time required by the users to manually and actively inquiry the positions of others and obtain information.

Other features and advantages of the present disclosure will be stated in the follow-up description, and partially become apparent in the description, or will be understood by implementation of the present disclosure. The objects and other advantages of the present disclosure can be achieved and obtained through structures specified in the written description, claims, and accompanying drawings.

Hereinafter, the technical solution of the present disclosure is further described in details through the accompanying drawings and embodiments.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a communication method for team travel of the present disclosure;

FIG. 2 is a flow chart of embodiment one of the present disclosure;

FIG. 3 is a flow chart of embodiment two of the present disclosure;

FIG. 4 is a schematic diagram of a structure in embodiment three of the present disclosure;

FIG. 5 is a schematic diagram of a structure in embodiment four of the present disclosure; and

FIG. 6 is a schematic diagram of a structure in embodiment six of the present disclosure.

### DETAILED DESCRIPTION

The specific embodiments of the present disclosure are described in details below in conjunction with the accompanying drawings, and it will be appreciated that the protection scope of the present disclosure is not limited by the specific embodiments.

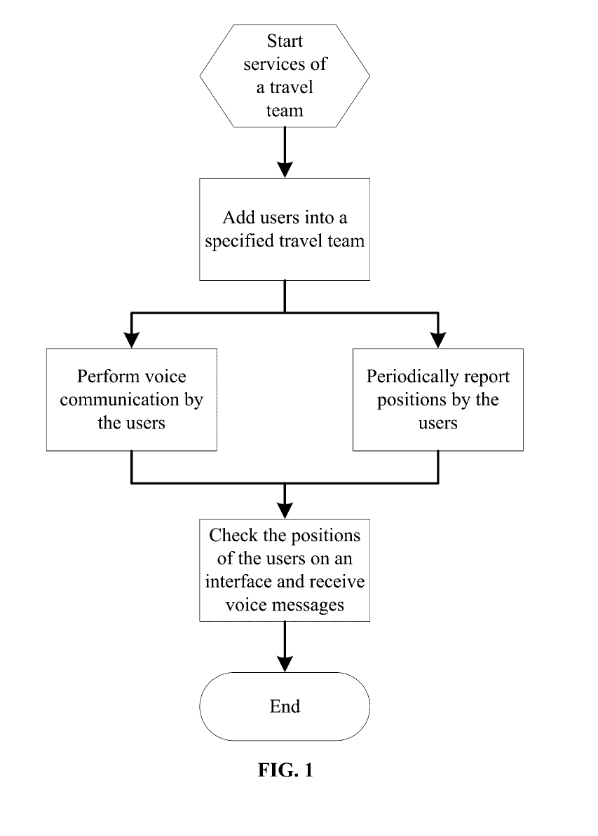

In order to solve the technical problem in the prior art that safe and effective position sharing and information communication cannot be performed during team travel, the present disclosure provides a method and electronic device of communication for team travel. The logic flow diagram of the communication method for team travel of the present invention is as shown in FIG. 1.

### The First Embodiment

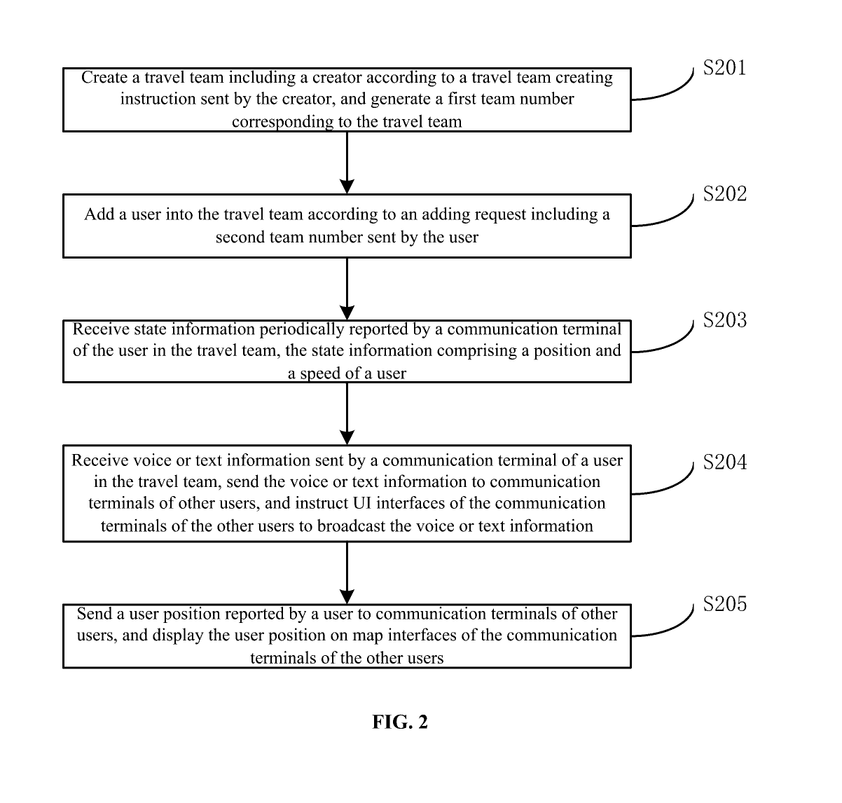

As shown in FIG. 2, a communication method for team travel of the present disclosure includes the following steps: S201˜S205.

In S201, a travel team including an initiator is created according to a travel team creating instruction sent by the initiator, and a first team numbering corresponding to the travel team is generated.

Creating the travel team includes generating a new travel team according to a user instruction, the initiator is added into the newly generated team automatically, a numbering corresponding to the team is generated at the same time, and other users can be added into this travel team through this numbering.

In S202, a user is added into the travel team according to an adding request including a second team numbering sent by the user.

The user is added into a designated travel team directly by taking the obtained numbering of the travel team as an identification ID.

In S203, an state information which is periodically reported by a communication terminal of a user in a travel team is received, the state information includes a position and a speed of a user.

The user, after being added into the travel team, periodically reports the state information, such as the current position, speed and the like.

In S204, a voice or character information sent by a communication terminal of a user in the travel team is received, the voice or character information is sent to communication terminals of other users, and an UI interface of the communication terminal of the other user is instructed to broadcast the voice or text information.

When necessary, the user can record voice or write characters and send the voice or text to a server.

In S205, the user position reported by the user is sent to communication terminals of other users, and the user position is displayed on map interfaces of the communication terminals of the other users.

All the users in the travel team can receive position information reported by the other users, and display the real-time positions of the other users on map interfaces of their own, and meanwhile, UI can automatically receive and broadcast the voice or text contents sent to the server by the other users.

The communication method of the present disclosure can allow the users, during team travel, for example, drive travel in a team, to be able to achieve real-time tracing of the positions of the users in a team through the technical solution of the present disclosure, and achieve mutual communication by voice, thereby realizing a communication function of team travel while ensuring the driving safety. The communication method of the present disclosure improves the efficiencies of position sharing and information interaction of team travel, and saves the time for the users to manually and actively inquiry the positions of others and obtain information.

### The Second Embodiment

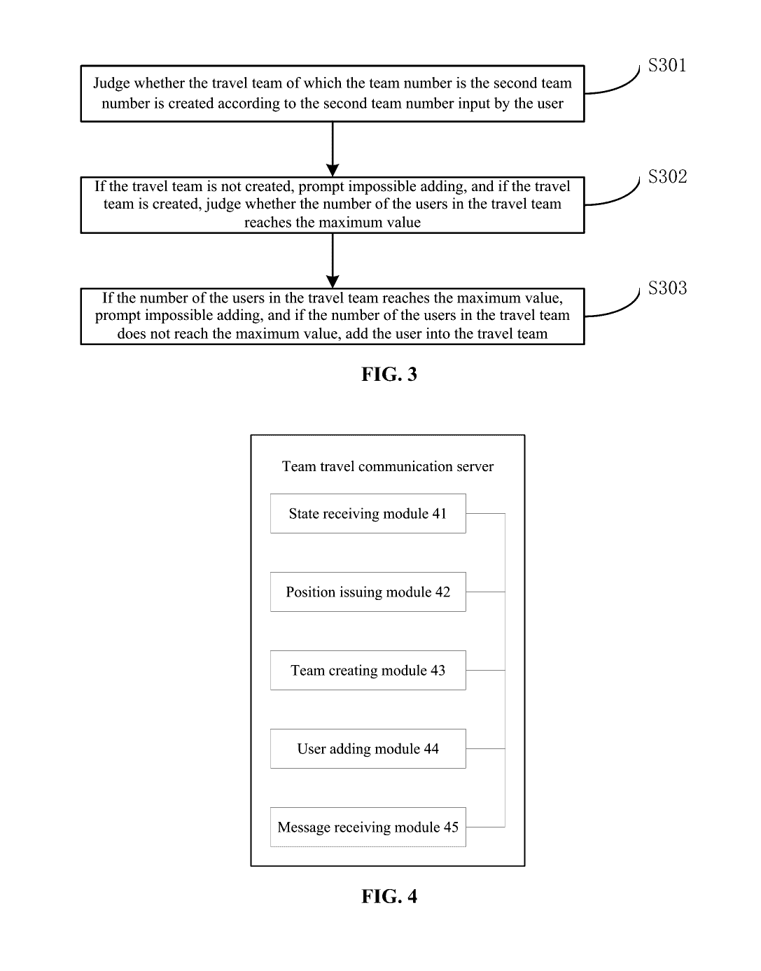

As shown in FIG. 3, step S202 of second embodiment is further illustrated, comprising the following steps: S301˜S303.

In S301, whether a travel team with a team numbering is in a created state or not is determined, according to the second team numbering input by the user, the team numbering is the second team numbering.

In S302, if the travel team is not in a created state, it is impossible to add is prompted, such as an information indicated impossible adding is prompted, and if the travel team is created, the number of the users in the travel team whether reaches the maximum value is determined.

In S303, if the numbering of the users in the travel team reaches the maximum value, it is impossible to add is prompted, such as an information indicated impossible adding is prompted, and if the numbering of the users in the travel team does not reach the maximum value, the user is added into the travel team.

The user inputs a numbering to judge whether the travel team taking this numbering as an identification ID is currently created, and if the travel team is not created, impossible adding is prompted. If this team is currently created, whether the numbering of the users in the team reaches the maximum value is determined, if so, a full numbering and an information indicated impossible adding are prompted. If the numbering of the users in the team is not full, the current user is added into the team.

This embodiment is further limitation to embodiment one, and has all the beneficial technical effects of embodiment one, which are not described herein.

### The Third Embodiment

As shown in FIG. 4, the present disclosure also provides a communication server for team travel, comprising: a state receiving module 41 and a position issuing module 42.

The state receiving module 41 receives state information periodically reported by a communication terminal of a user in a travel team, the state information includes a position and a speed of a user.

The position issuing module 42 sends the user position reported by the user to communication terminals of other users, and displays the user position on map interfaces of the communication terminals of the other users.

In one embodiment, the communication server also includes: a team creating module 43 and a user adding module 44.

The team creating module 43 creates a travel team including a initiator according to a travel team creating instruction sent by the initiator, and generates a first team numbering corresponding to the travel team.

The user adding module 44 adds a user into the travel team according to an adding request including a second team numbering sent by the user.

In one embodiment, the communication server also includes: a message receiving module 45.

The message receiving module 45 receives voice or text information sent by a communication terminal of a user in the travel team, sends the voice or text information to communication terminals of other users, and instructs UI interfaces of the communication terminals of the other users to broadcast the voice or text information.

In one embodiment, the user adding module 44 is specifically used for: determining whether the travel team of which the team numbering is the second team numbering is created, according to the second team numbering input by the user; if the travel team is not created, prompting impossible adding, and if the travel team is created, determining whether the numbering of the users in the travel team reaches the maximum value; and if the numbering of the users in the travel team reaches the maximum value, prompting impossible adding, and if the numbering of the users in the travel team does not reach the maximum value, adding the user into the travel team.

### The Fourth Embodiment

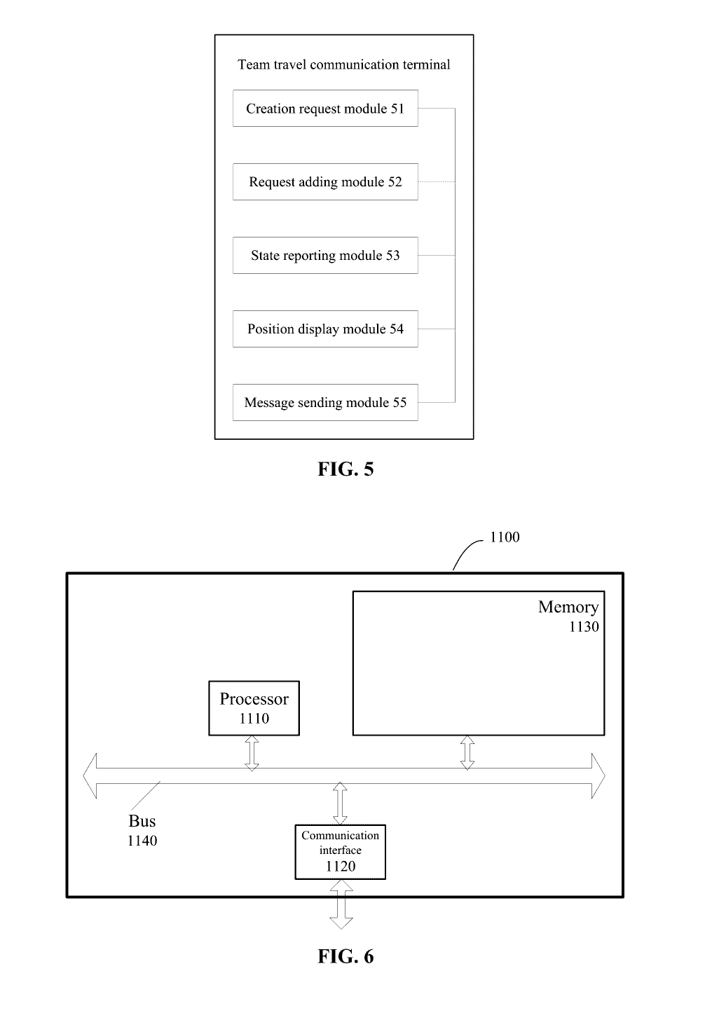

As shown in FIG. 5, the present disclosure also provides a communication terminal for team travel, includes a creating request module 51, a request adding module 52, a state reporting module 53 and a position display module 54.

The creating request module 51 is used for sending a travel team creating request to a travel team communication server, and instructing the travel team communication server to create a travel team including a initiator and generate a corresponding team numbering.

The request adding module 52 is used for, according to the corresponding team numbering, sending an adding request to the travel team communication server, and adding into the travel team.

The state reporting module 53 is used for periodically reporting self-state information to the travel team communication server, the state information comprising a position and a speed of a user.

The position display module 54 is used for receiving user positions of other users issued by the travel team communication server, and displaying on self-map interfaces.

In one embodiment, the communication terminal also includes: a message sending module 55.

The message sending module 55 is used for sending voice or text information to the travel team communication server to ensure that the travel team communication server sends the voice or text information to UI interfaces of communication terminals of other users for broadcasting.

### The Fifth Embodiment

The present disclosure also provides a communication system for team travel, includes: the communication server for team travel described in the third embodiment and the communication terminal for team travel described in the fourth embodiment.

The communication system for team travel of the present disclosure has all the beneficial technical effects of first embodiment to the fourth embodiment, which are not described herein.

The present disclosure may have various specific embodiments in different forms, the technical solution of the present disclosure is illustrated above by taking FIG. 1-FIG. 5 as examples in combination with the accompanying drawings, and this does not mean that the specific examples employed by the present disclosure can only be limited in specific processes or embodiment structures; and it will be appreciated by those of ordinary skill in the art that the above-mentioned specific embodiments are just some examples of a variety of preferred usages, and any embodiment embodying the claims of the present disclosure shall be within the protection scope claimed by the technical solution of the present disclosure.

Finally, it should be explained that: what mentioned above are only preferred embodiments of the present disclosure, and are not used for limiting the present disclosure; and although the present disclosure is described in details with reference to the above-mentioned embodiments, those skilled in the part still can modify the technical solution stated by the above-mentioned embodiments, or equivalently substitute part of the technical features therein. Within the spirit and principle of the present disclosure, any modification, equivalent substitution, improvement, etc., should be incorporated in the protection scope of the present disclosure.

### The Sixth Embodiment

FIG. 6 illustrates a block diagram of a structure of a network device in another embodiment of the present invention. The network device 1100 may be a host server, a personal computer (PC), or a portable computer or terminal and the like with computing power. The specific embodiments of the present invention do not limit concrete implementation of computing nodes.

The network device 1100 includes a processor 1110, a communications interface 1120, a memory (memory array) 1130 and a bus 1140, wherein the processor 1110, the communications interface 1120 and the memory 1130 communicate with one another through the bus 1140.

The communications interface 1120 is used for communicating with a network element, wherein the network element includes, for example, a virtual machine management center, shared storage and the like.

The processor 1110 is used for executing programs. The processor 1110 may be a central processing unit (CPU), or an ASIC (Application Specific Integrated Circuit), or one or more integrated circuits configured to implement the embodiments of the present invention.

The memory 1130 is used for storing files. The memory 1130 may comprise a high-speed RAM memory, and may also comprise a non-volatile memory, for example, at least one disk memory. The memory 1130 also can be a memory array. The memory 1130 may also be partitioned into blocks, and the blocks can be combined into a virtual volume according to a certain rule.

In a possible embodiment, the above-mentioned program may be program codes comprising computer operating instructions. Specifically, the program can be used for: on the one hand, providing a communication method for team travel, comprising: receiving state information periodically reported by a communication terminal of a user in a travel team, the state information comprising a position and a speed of a user; and sending the user position reported by the user to communication terminals of other users, and displaying the user position on map interfaces of the communication terminals of the other users.

In a possible embodiment, before the step of receiving state information periodically reported by a communication terminal of a user in a travel team, the state information comprising a position and a speed of a user, the method also includes: creating a travel team including a initiator according to a travel team creating instruction sent by the initiator, and generating a first team numbering corresponding to the travel team; and adding a user into the travel team according to an adding request including a second team numbering sent by the user.

In a possible embodiment, the communication method also includes: receiving voice or text information sent by a communication terminal of a user in the travel team, sending the voice or text information to communication terminals of other users, and instructing UI interfaces of the communication terminals of the other users to broadcast the voice or text information.

In a possible embodiment, the step of adding a user into the travel team according to an adding request including a second team numbering sent by the user includes: determining whether the travel team of which the team numbering is a second team numbering is created according to the second team numbering input by the user; if the travel team is not created, prompting impossible adding, and if the travel team is created, determining whether the numbering of the users in the travel team reaches the maximum value; and if the numbering of the users in the travel team reaches the maximum value, prompting impossible adding, and if the numbering of the users in the travel team does not reach the maximum value, adding the user into the travel team.

On the other hand, providing a communication method for team travel, comprising: sending a travel team creating request to a travel team communication server, and prompting the travel team communication server to create a travel team including a initiator and generate a corresponding team numbering; according to the corresponding team numbering, sending an adding request to the travel team communication server, and adding the request into the travel team; periodically reporting self-state information to the travel team communication server, the state information comprising a position and a speed of a user; and receiving user positions of other users issued by the travel team communication server, and displaying the user positions on map interfaces of the users.

In a possible embodiment, the communication method also includes: sending voice or text information to the travel team communication server to ensure that the travel team communication server sends the voice or text information to UI interfaces of communication terminals of other users for broadcasting.

It will be appreciated by those skilled in the art that the embodiments of the present invention can provide a method, a system, or a computer program product. Therefore, the present invention can adopt a form of full-hardware embodiments, full-software embodiments, or embodiments with combination of hardware and software. Moreover, the present invention can adopt a form of the computer program product implemented on one or more computer-available storage media (including but not limited to a disk memory and an optical memory, etc.) containing computer-available program codes.

The present invention is described with reference to the flow diagram and/or block diagram of the method, the device (system), and the computer program product according to embodiments of the present invention. It should be appreciated that every flow and/or block in the flow diagram and/or block diagram, and the combination of the flows and/or blocks in the flow diagram and/or block diagram can be implemented by computer program instructions. These computer program instructions can be provided to a processor of a general-purpose computer, a special-purpose computer, an embedded type processor or other programmable data processing equipment to create a machine so as to ensure that the instructions executed by the processor of a computer or other programmable data processing equipment create a device for realizing a specified function in one or more flows of the flow diagram and/or one or more blocks of the block diagram.

The embodiment of the present invention provides a non-transitory computer-readable storage medium storing executable instructions that, when executed by an electronic device, cause the electronic device to execute the processing method in the case of any method embodiment mentioned above.

These computer program instructions also can be stored in a computer-readable memory which can guide the computer or other programmable data processing equipment to work in a specific mode, so that the instructions stored in the computer-readable memory generate a manufactured product comprising an instruction device which realizes the specific function in one or more flows of the flow diagram and/or one or more blocks of the block diagram.

These computer program instructions also can be loaded to the computer or other programmable data processing equipment to ensure that a series of operation steps are executed on the computer or other programmable data processing equipment so as to generate computer-implementing processing, so that the instructions executed on the computer or other programmable data processing equipment provide steps for realizing the specific function in one or more flows of the flow diagram and/or one or more blocks of the block diagram.

The above descriptions of the specific exemplary embodiments of the present invention are for the purpose of explanation and illustration. These descriptions do not intend to limit the present invention as a disclosed precise form, and it is apparent that, in accordance with the above instructions, a variety of changes and variations can be carried out. The purpose of selecting and describing the exemplary embodiments is to explain the specific principles and practical application of the present invention, so that those skilled in the art to can achieve and use a variety of different exemplary embodiments of the present invention and a variety of options and changes. The scope of the present invention is intended to be limited by the claims and an equivalent form thereof.

What is claimed is:

1. A method of communication for team travel, which is applied by a server, comprising:
step A: receiving state information periodically reported by a communication terminal of a user in a travel team, the state information comprising a user position and a speed; and
step B: sending the user position reported by the user to communication terminals of other users among the travel team, and displaying the user position on map interfaces of the communication terminals of the other users.

2. The method according to claim 1, further comprising the following steps before step A:
step C: creating a travel team including a initiator according to a travel team creating instruction sent by the initiator, and generating a first team numbering corresponding to the travel team; and
step D: adding a user into the travel team according to an adding request including a second team numbering sent by the user.

3. The method according to claim 1, further comprising:
step E: receiving voice or text information sent by the communication terminal of the user in the travel team, sending the voice or text information to communication terminals of other users, and instructing UI interfaces of the communication terminals of the other users to broadcast the voice or text information.

4. The method according to claim 2, wherein, the step of adding a user into the travel team according to an adding request including a second team numbering sent by the user comprises:
determining whether the travel team with a team numbering which is the second team numbering is in a created state according to the second team numbering input by the user;
if the travel team is not in a created state, prompting that it is impossible to add, and if the travel team is in a created state, determining whether the number of the users in the travel team reaches the maximum value;
if the number of the users in the travel team reaches the maximum value, prompting that it is impossible to add, and if the number of the users in the travel team does not reach the maximum value, adding the user into the travel team.

5. An electronic device, comprising:
at least one processor; and
a memory communicably connected with the at least one processor for storing instructions executable by the at least one processor, wherein execution of the instructions by the at least one processor causes the at least one processor to:
receiving state information periodically reported by a communication terminal of a user in a travel team, the state information comprising a user position and a speed; and
sending the user position reported by the user to communication terminals of other users, and displaying the user position on map interfaces of the communication terminals of the other users.

6. The electronic device according to claim 5, wherein execution of the instructions by the at least one processor causes the at least one processor to:
creating a travel team including a initiator according to a travel team creating instruction sent by the initiator, and generating a first team numbering corresponding to the travel team; and
adding a user into the travel team according to an adding request including a second team numbering sent by the user.

7. The electronic device according to claim 5, wherein execution of the instructions by the at least one processor causes the at least one processor to:
receiving voice or text information sent by the communication terminal of the user in the travel team, sending the voice or text information to communication terminals of other users, and instructing UI interfaces of the communication terminals of the other users to broadcast the voice or text information.

8. The electronic device according to claim 6, wherein execution of the instructions by the at least one processor causes the at least one processor to:
determining whether the travel team with a team numbering which is the second team numbering is in a created state according to the second team numbering input by the user;
if the travel team is not in a created state, prompting that it is impossible to add, and if the travel team is in a created state, determining whether the number of the users in the travel team reaches the maximum value;
if the number of the users in the travel team reaches the maximum value, prompting that it is impossible to add, and if the number of the users in the travel team does not reach the maximum value, adding the user into the travel team.

9. A non-transitory computer-readable storage medium storing executable instructions that, when executed by an electronic device, cause the electronic device to:
receiving state information periodically reported by a communication terminal of a user in a travel team, the state information comprising a position and a speed of the user; and
sending the user position reported by the user to communication terminals of other users, and displaying the user position on map interfaces of the communication terminals of the other users.
